(19) United States
(12) Patent Application Publication
(10) Pub. No.: US 2024/0400389 A1
(43) Pub. Date: Dec. 5, 2024

(54) OFF-GAS PRODUCTION UTILIZATION FOR SRU SUPERCLAUS CONVERTOR SAFETY

(71) Applicant: SAUDI ARABIAN OIL COMPANY, Dhahran (SA)

(72) Inventors: Bader Inad Alotaibi, Jubail (SA); Abdullah Al Arifi, Dhahran (SA); Ahmad Almousa, Al Qatif (SA); Abdullah Alhumaid, Khobar (SA)

(73) Assignee: SAUDI ARABIAN OIL COMPANY, Dhahran (SA)

(21) Appl. No.: 18/326,925

(22) Filed: May 31, 2023

(51) Int. Cl. C01B 17/04

(52) U.S. Cl. CPC C01B 17/046

(57) ABSTRACT

A quench system for sulfur recovery including a quench line for delivering a CO₂ rich off gas into a feed line of the sulfur recovery unit converter system, an oxidation air inlet for feeding an oxidation air to an oxidation air preheater, a feed preheater for receiving the heated oxidation air, the CO₂ rich off gas, the process gas, or a combination thereof, a selective oxidation converter disposed downstream of the feed preheater for producing a converter effluent, an off gas control valve disposed in the quench line for controlling the CO₂ rich off gas to the selective oxidation converter, wherein the CO₂ rich off gas is used for quenching a potential fire, and cooling preheaters and a selective oxidation converter when temperature exceeds normal operating limits or fire is suspected.

### BACKGROUND

In the sulfur recovery industry, multiple processes are being used in which the design differs to deliver a certain product spec. In some gas plants, the Sulfur Recovery Unit (SRU) plant utilizes a modified SUPERCLAUS process to convert the acid gas containing Hydrogen Sulfide (H₂S) to elemental sulfur. Overall, due to the extreme nature of the process, the high temperatures, and the harmful/fire risk elements, the design of the equipment in these processes needs to include a fire suppressing/protection system. The catalytic convertor (i.e., the last of the three convertor) does not have a method to protect the catalyst in case of a fire erupting.

With the nature of the selective oxidation catalyst in the convertor needing to be conditioned at higher temperatures during the startup of the process, the risk of fires erupting is higher than the other convertors in the process. These convertors are generally not equipped with any method to suppress the fire but to close of the supply of gas through an inlet safety isolation valve but would keep the fire unaddressed until it dies out and affects the costly catalyst inside

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a quench system for sulfur recovery unit converter system. The system includes a quench line configured for delivering a CO₂ rich off gas into a feed line of the sulfur recovery unit converter system, an oxidation air inlet configured for feeding an oxidation air to an oxidation air preheater, the oxidation air preheater configured to provide a heated oxidation air to the feed line, a feed preheater configured for receiving the heated oxidation air, the CO₂ rich off gas, the process gas, or a combination thereof, a selective oxidation converter disposed downstream of the feed preheater, the selective oxidation converter configured for producing a converter effluent, an off gas control valve disposed in the quench line and configured for controlling the CO₂ rich off gas to the selective oxidation converter, wherein, the CO₂ rich off gas is used for quenching a potential fire, and cooling preheaters and a selective oxidation converter when temperature exceeds normal operating limits or fire is suspected.

In another aspect, embodiments disclosed herein related to a purge system for sulfur recovery unit converter. The system includes a quench line configured for delivering a CO₂ rich off gas into a feed line of the sulfur recovery unit converter system, an oxidation air inlet configured for feeding an oxidation air to an oxidation air preheater, the oxidation air preheater configured to provide a heated oxidation air to the feed line, a feed preheater configured for receiving the heated oxidation air, the CO₂ rich off gas, the process gas, or a combination thereof, a selective oxidation converter disposed downstream of the feed preheater, the selective oxidation converter configured for producing a converter effluent, and wherein, the CO₂ rich off gas used for purging and cooling preheaters and a selective oxidation converter when sulfur levels in process gas exceed operating limits, or during start up or shut down

Other aspects and advantages of the claimed subject matter will be apparent from the following description and the appended claims.

### BRIEF DESCRIPTION OF DRAWINGS

FIG. 1 is a schematic of a selective oxidation stage with quench system.

### DETAILED DESCRIPTION

In one aspect, embodiments disclosed herein relate to a quench system configured to use of a CO₂ rich off gas for prevention or suppression of potential fires in high temperature selective oxidation converters employed in sulfur recovery units (SRU). The high temperature selective oxidation reactors are commonly used in modified EUROCLAUS® and SUPERCLAUS® installations. Due to hazards associated with high temperatures in the presence of sulfur and oxygen, the design of these processes should include a fire suppression and protection system. The availability of CO₂ rich off gas from sour gas treating units (or gas sweetening units) provides the opportunity to configure a quench system for fire prevention and suppression.

Gas sweetening units are configured to remove acid gas contaminants, such as carbon dioxide (CO₂), hydrogen sulfide (H₂S), mercaptans and other contaminants from natural gas. Gas sweetening, or treating, is accomplished mainly through the use of amine absorbers. Acid gas enrichment is one aspect of the gas treating process that increases the H₂S concentration in the acid gas, or process gas, entering a sulfur recovery unit (SRU). The remaining CO₂ rich off gas is sent to a thermal oxidizer to remove trace hydrocarbons. The CO₂ rich off gas typically has greater than 95 mol % CO₂ and greater than 4 mol % water.

Carbon dioxide is routinely utilized as a fire suppressant in fire extinguishers and fire suppression systems. Therefore, there is an opportunity to use the CO₂ rich off gas from sour gas treating units in a beneficial manner, as a quench gas for a fire suppressant system. An embodiment of this disclosure is to take advantage of the high CO₂ composition, low temperature (110° F.) off gas and use it to improve upon the safety of selective oxidation convertors in case of high temperatures or potential fire scenarios.

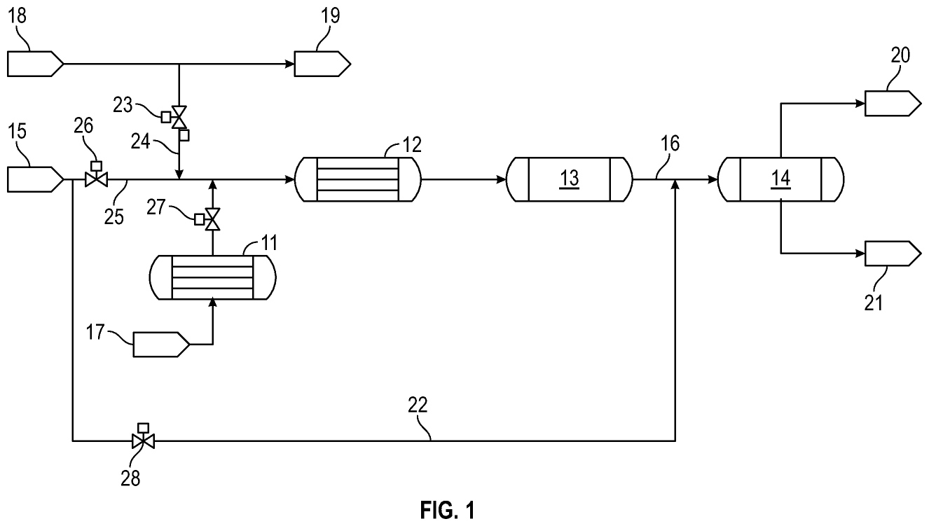

FIG. 1 shows a schematic of a selective oxidation converter unit with a quench system utilizing the CO₂ rich off gas from a gas sweetening unit. Feed to the gas processing plant consists of process gas [15] comprising 30-80 mol % H₂S, less than 2 mol % hydrocarbons with balance CO₂. The SRU typically operates with two stages with conventional Claus converters upstream of the selective oxidation, or SUPERCLAUS®, converter. The amount of H₂S going to the selective oxidation converter is significantly lower than that in the process gas, typically in the range of 0.5 to 2 mol % H₂S. Oxidation air is introduced to provide a slight excess of oxygen to directly oxidize H₂S to elemental sulfur according to the following stoichiometry:

H₂S+½O₂→S+H₂O

During normal operation oxidation air [17] is fed to an oxidation air preheater [11] before it is mixed with the process gas [15] upstream of the feed preheater [12]. The feed mixture of process gas [15] and oxidation air [17] is preheated to temperatures ranging from 375° F. to 450° F. before it is sent to the selective oxidation converter [13]. Effluent from the selective oxidation converter [16] is then sent to the condenser [14] where liquid sulfur [21] is separated from tail gas [20]. Liquid sulfur [21] is collected and shipped offsite, while tail gas [20] is routed to a thermal oxidizer (not shown). CO₂ rich off gas [18] bypasses the SRU and is sent to a thermal oxidizer [19] during normal operations.

The risk of fire exists in the presence of sulfur or pyrophoric iron sulfide, FeS, that may accumulate in the process equipment, especially during upset conditions. Also, the autoignition temperature of sulfur in the process is in the range of 450° F. to 500° F. The risk of fire is low during normal operation with low excess oxygen, but excess oxygen may be introduced during shutdown, startup, or hot standby operations. For example, ingress of oxygen may occur if air is used as a purge for burners, or when FeS is oxidized into iron oxide, Fe₂O₃, during shutdown.

An exothermic reaction can lead to temperature runaway when a new batch of catalyst has not been conditioned carefully. In short, the catalyst conditioning procedure is completed to replace oxygen on the active sites of the catalyst with sulfur. This prevents the rapid, exothermic, reaction of H₂S to SO₂ instead of the preferred selective oxidation reaction producing sulfur. Temperature runaways can approach 900° F. which will damage the catalyst.

In the event that the selective oxidation converter [13] exceeds normal 625° F., a sudden rise to 750° F., or conditions or fire are suspected, CO₂ rich off gas [18] from the sweetening unit is introduced via the quench control valve [23]. At the same time, the system will isolate the selective oxidation converter [13] by shutting off an oxidation air control valve [27] and a process gas control valve [26] and routing process gas [15] to bypass [22]. Process gas is then set to bypass [22] the selective oxidation converter [13] by opening the bypass control valve [28] and feeding the process gas to a location downstream of the selective oxidation converter [13] and upstream of the condenser [14].

The risk of fire may be limited by the availability of oxygen and sulfur. The CO₂ rich off gas [18] provides an alternative to purging with air which contains oxygen, or nitrogen which is less cost effective. Purge operations are typically focused on preventing sulfur accumulations in process equipment. An embodiment of this disclosure provides an option to improve upon safety through use of CO₂ rich off gas [18] to purge reactive oxygen and sulfur containing compounds from the unit. The low temperature low temperature CO₂ rich off gas [18] may also aid in controlling the temperature of process equipment during upset conditions or shutdown.

Oxygen concentrations may increase during heat up, shut down, or bypass of the selective oxidation converter [13]. Operation of the bypass [22] is warranted when inlet H₂S levels exceed operating limits or with high temperature in the selective oxidation converter [13]. Bypass [22] while switching to purge with oxidation air [17] is common to maintain oxidizing conditions in the catalyst bed. Purge gas also provides cooling and prevents backflow of sulfur from the converter effluent [16] of the selective oxidation converter [13].

Embodiments of the present disclosure may provide at least one of the following advantages. Utilizing CO₂ rich off gas [18] for a fire prevention or quench system, as well as an option for purging the selective oxidation converter [13] unit, including the preheaters [12] and condenser [14]. A quench line [24] configured with an off gas control valve [23] for delivering CO₂ rich off gas as a quench gas, purge gas or fire suppressant into the feed line [25] to a unit including an oxidation air heater[11], preheaters [12], a selective oxidation converter [13] and a condenser [14]. The quench line configured to deliver CO₂ rich off gas upstream of oxidation air [17] and preheaters [12]. A quench line configured for routing off gas to thermal oxidizer, not shown, during normal operation.

A bypass [22] configured with a bypass control valve [28] to divert process gas [15] around the process gas control valve [26], oxidation air [17], preheaters [12] and selective oxidation converter [13]. A bypass [22] configured to divert process gas [15] from a selective oxidation converter [13], or SUPERCLAUS®, unit in case temperature exceeds operating limits or a potential fire scenario. A bypass configured to divert process gas [15] from a selective oxidation converter [13], or SUPERCLAUS®, unit during shut down, start up or in case sulfur levels exceed operating limits.

What is claimed:

1. A quench system for sulfur recovery unit converter system, comprising:
a quench line configured for delivering a CO₂ rich off gas into a feed line of the sulfur recovery unit converter system;
an oxidation air inlet configured for feeding an oxidation air to an oxidation air preheater, the oxidation air preheater configured to provide a heated oxidation air to the feed line;
a feed preheater configured for receiving the heated oxidation air, the CO₂ rich off gas, the process gas, or a combination thereof;
a selective oxidation converter disposed downstream of the feed preheater, the selective oxidation converter configured for producing a converter effluent;
an off gas control valve disposed in the quench line and configured for controlling the CO₂ rich off gas to the selective oxidation converter;
wherein, the CO₂ rich off gas is used for quenching a potential fire, and cooling preheaters and a selective oxidation converter when temperature exceeds normal operating limits or fire is suspected.

2. A system of claim 1, wherein the CO₂ rich off gas is obtained from a gas sweetening unit, comprising at least 95 mol % CO₂ and at least 4 mol % water.

3. A system of claim 1, comprising:
a bypass control valve configured for diverting the process gas from a location upstream of the quench line to the converter effluent,
a condenser configured for separating a liquid sulfur product and a tail gas from the converter effluent,
wherein the tail gas stream is routed to a thermal oxidizer.

4. A purge system for sulfur recovery unit converter, comprising:
a quench line configured for delivering a CO₂ rich off gas into a feed line of the sulfur recovery unit converter system;
an oxidation air inlet configured for feeding an oxidation air to an oxidation air preheater, the oxidation air preheater configured to provide a heated oxidation air to the feed line;
a feed preheater configured for receiving the heated oxidation air, the CO₂ rich off gas, the process gas, or a combination thereof;
a selective oxidation converter disposed downstream of the feed preheater, the selective oxidation converter configured for producing a converter effluent;
wherein, the CO₂ rich off gas used for purging and cooling preheaters and a selective oxidation converter when sulfur levels in process gas exceed operating limits, or during start up or shut down.

5. A system of claim 4, wherein the CO₂ rich off gas is obtained from a gas sweetening unit, comprising at least 95 mol % CO₂ and at least 4 mol % water.

6. A system of claim 4, comprising:
a bypass control valve configured for diverting the process gas from a location upstream of the quench line to the converter effluent,
a condenser configured for separating liquid sulfur and tail gas from the converter effluent,
wherein the tail gas stream is routed to a thermal oxidizer.

7. A method for purging a sulfur recovery unit converter comprising, the method comprising:
feeding a process gas to a selective oxidation converter for converting a mixture of H₂S and O₂ to elemental sulfur and H₂O;
wherein the process gas contains 0.5 to 2.0 mol % H₂S;
wherein an oxidation air containing 21 mol % O₂ is mixed with the process gas upstream of the selective oxidation converter;
purging a selective oxidation converter and preheaters with CO₂ rich off gas when temperatures exceed normal operating limits or potential for fire is suspected; and
closing an oxidation air control valve to stop the flow of oxidation air to the preheaters and selective oxidation converter; and
closing a bypass control valve to divert process gas from the feed to the selective oxidation converter effluent; and
closing a process gas control valve to stop the flow of process gas to the preheaters and selective oxidation converter; and
opening an off gas control valve to feed CO₂ rich off gas for purging the preheaters and selective oxidation converter.

8. A method of claim 7, comprising:
using CO₂ rich off gas obtained from a gas sweetening unit, comprising at least 95 mol % CO₂ and at least 4 mol % water, as a purge gas.
wherein, the CO₂ rich off gas is sent to a thermal oxidizer during normal operations.

9. A method of claim 7, comprising:
opening a bypass control valve configured for bypassing process gas around the selective oxidation converter from a location upstream of the quench line to the converter effluent; and
separating liquid sulfur product from the converter effluent using a condenser, and
sending tail gas stream to a thermal oxidizer.
